(19) United States
(12) Patent Application Publication
(10) Pub. No.: US 2026/0266144 A1
(43) Pub. Date: Sep. 10, 2026

(54) Dead Short Switch and Method of Use

(71) Applicant: Gunnar LLLP, Magnolia, TX (US)

(72) Inventors: Clinton Moss, Bakersfield, CA (US); Frederik Chad Moss, Bakersfield, CA (US); Arthur La Porta, Ventura, CA (US)

(73) Assignee: Gunnar LLLP, Magnolia, TX (US)

(21) Appl. No.: 19/556,009

(22) Filed: Mar. 4, 2026

Related U.S. Application Data
(60) Provisional application No. 63/768,017, filed on Mar. 6, 2025.

(51) Int. Cl. E21B 17/02; H01H 3/24; H01H 3/26; H01H 3/28; H01H 9/54

(52) U.S. Cl. CPC E21B 17/0285; H01H 3/24; H01H 3/26; H01H 3/28; H01H 9/54; H01H 2003/268

(57) ABSTRACT

A downhole dead short switch provides dual-mode current routing for drilling and ranging systems. The device includes a conductive upper housing, an electrically insulated lower section, and a non-conductive piston carrying brush contactors. A microcontroller-driven actuator repositions the piston between a dead-short state (for AC or DC current injection to formation) and a communication state (for low-power telemetry to a sensor). The assembly may be filled with dielectric oil, and incorporates sensors and logic for feedback and fail-safe auto-recovery. The system enables automatic switching between stimulation and communication and can also perform downhole DC power recharge or solenoid actuation.

### FIELD OF THE INVENTION

The present inventions pertain to downhole electrical and telemetry systems used in drilling operations, and more specifically to a switching apparatus for selecting between high-current formation injection and low-current sensor communication or power delivery within a wired drill pipe or similar conduit.

### BACKGROUND OF THE INVENTION

Wired drill pipe technology permits broadband communication and power transmission between surface equipment and downhole tools.

During ranging-while-drilling operations, current is injected into a formation to stimulate a conductive target such as another well casing. Such excitation typically involves hundreds of volts and tens of amps.

After excitation, downhole sensors require reconnection for telemetry at low current levels (fractions of an amp). Exposing sensors to injection current can cause permanent damage.

Existing systems lack a reliable downhole isolation and reconfiguration mechanism that can transition quickly between dead-short injection and communication modes without tripping the string.

Accordingly, a need exists for a robust, controllable downhole switching mechanism capable of handling high voltage and current, while maintaining full isolation of sensitive instrumentation.

### SUMMARY OF THE INVENTION

The invention provides a dead short switch enabling electrical reconfiguration between:
(a) a dead-short mode for current injection to the formation, and
(b) a communication mode for safe telemetry and power delivery to downhole sensors or other tools.

The switch can comprise an EM gap sub having a tubular body having a conductive upper portion connected to the pipe body and an insulative lower portion. A non-conductive piston inside the body carries electrical contactors which, depending on piston position, either connect an insulated line to ground or to the tool power circuit.

The piston can be moved by an actuator, such as a solenoid, hydraulic driver, or linear motor, under command of a control module capable of decoding electrical, hydraulic, or telemetry-based signals.

Optional feedback and fail-safe logic ensure reliable operation under extreme temperature and pressure, permitting seamless integration into wired-pipe or wireline systems.

### BRIEF DESCRIPTION OF THE DRAWINGS

FIG. 1A is a system level diagram showing typical components in a magnetic while ranging system.

FIG. 1B is a system level diagram showing the dead short switch and its connection to the wired pipe and the MWD collar.

FIG. 2A is a sectional view of the wired pipe shown in FIG. 1A.

FIG. 2B is a sectional view of the dead short switch in the dead short-current injection position.

FIG. 3 is a sectional view of the switch in a communication position.

FIG. 4 is a schematic electrical diagram illustrating one configuration of the switch.

FIG. 5 is a schematic electrical diagram illustrating an additional configuration of the switch.

FIG. 6 is a component diagram of an electrical switch in current injection mode.

FIG. 7 is a component diagram of an electrical switch in communications mode.

### DETAILED DESCRIPTION OF THE INVENTION

### General Construction

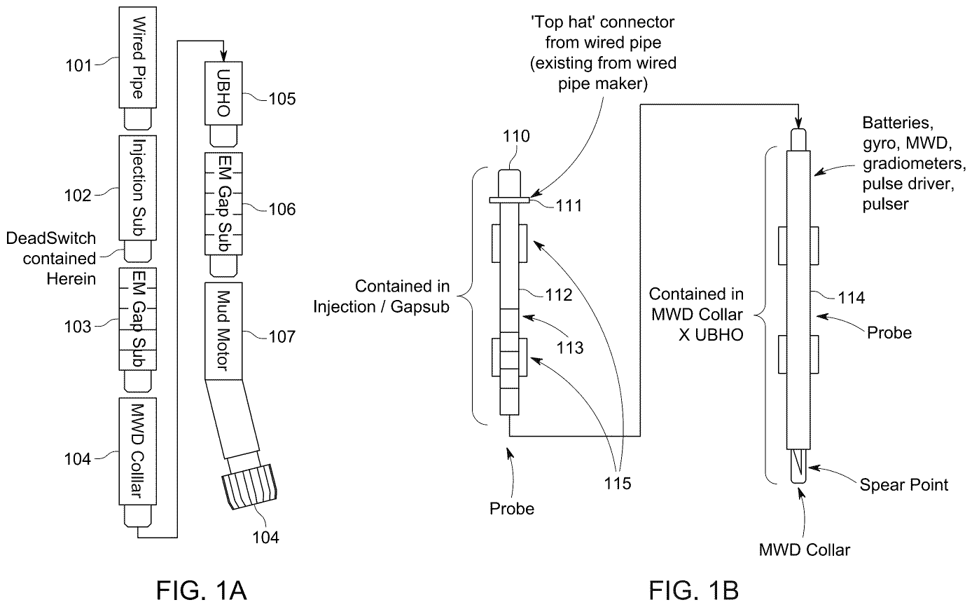

FIG. 1A is a system level diagram showing the switch in a ranging while drilling system. In FIG. 1A a section of wired pipe 101 is connected to an injection sub 102. The injection sub 102 is a downhole sub which routes ranging injection current into the formation above an insulative gab sub. The injection sub therefore acts as the emitter electrode for the ranging system. The injection sub 102 has at least one electrically insulative gab sub 103 below it, or alternatively the electrical isolation and current injection functions of the EM gap sub and the injection sub can be designed into a single sub. Below the EM gap sub 103 is an MWD collar 104 and a UBHO 105. The UBHO (Universal Bottom Hole Orientation) sub is a specialized component in a directional drilling Bottom Hole Assembly (BHA) used to orient downhole tools. Often called a “mule shoe” sub, it can contain a landing sleeve to house steering tools, allowing precise measurement of the tool face direction, azimuth, and inclination. It should be noted that a UBHO is but one way to affix and orient the MWD and ranging sensors in the BHA. Rigid bottom or top mounting of the sensor components are also routinely deployed, and are familiar to those of skilled in the art. Connected to the UBHO is an additional (optional) EM sub 106. EM gap sub 106 is connected to mud motor 107, which is connected to drill bit 108. Other subs or BHA components can be present as required (e.g., rotary steering components, etc.). This BHA description is for illustrative purposes only, as anyone skilled in the art would appreciate. Another embodiment could use wireline for the injection and/or communication line or a wireline landed in a special UBHO. Still other embodiments include any type of wire inside any type of pipe that can mate to a switch.

FIG. 1B is a schematic showing the connection of the switch 110 to the wired pipe and the MWD collar/UBHO. The switch can be contained in the injection sub 102 or the EM gap sub 103 of FIG. 1A. Switch contains a top hat type connector 111. It should be noted that the “top hat” connector is but one way to achieve mating of electrical connections with BHA tubulars. It should be noted that there are many other commercially available methods which allow electronics contained within separate tubulars to be electrically connected during the process of mechanically connecting the BHA tubulars. Switch is comprised of an upper conductive portion 112 and a lower non-conductive portion 113. Rubberized fin centralizers 115 are contained on outer circumference of switch to ensure that switch maintains its central location in EM sub. At its lower end, switch contains a connector that is capable of connecting to the MWD collar. Alternatively, the switching mechanism could be contained in an insert style flow through configuration, but is still contained in mechanically load bearing BHA tubulars.

MWD collar may contain a probe 114 having batteries, gyro instruments, gradiometers, pulse drivers and other customary sensors for magnetic ranging systems. Probe may also contain rubberized fin centralizers.

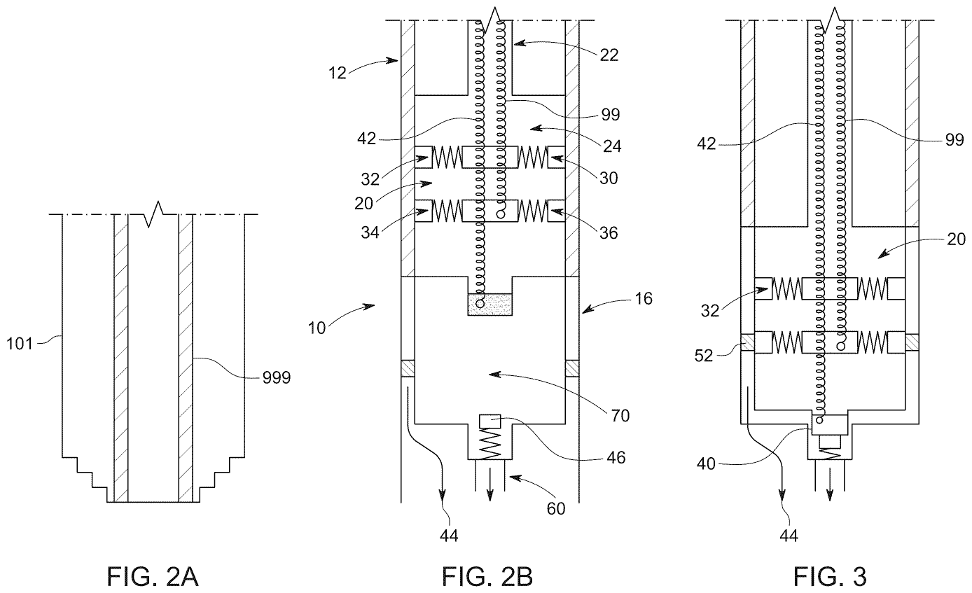

FIG. 2B is a sectional diagram of the “dead short” switch 10. In FIG. 2B, the dead short switch 10 is in the current injection position. The dead short switch 10 has an elongated tubular housing incorporating both metallic and non-conductive portions.

The upper section 12 of the switch body is a conductive material such as steel and is galvanically connected to the body of a section of pipe, functioning as a ground return during current injection.

The lower section 16 is fabricated from a non conductive material such as PEEK, ceramic, or an electrically insulative composite material. The non-conductive portion isolates the downhole sensor assembly 60 and prevents current leakage along the tool housing.

Contained within the body is a piston assembly 20 that moves axially under the operation of an actuator 22. The actuator may be a solenoid, linear motor, hydraulic driver, or any other type of actuator capable of moving the piston assembly and capable of withstanding high temperature and pressure conditions.

The piston body 24 is substantially non-conductive but carries one or more brush contactors 30, 32, 34, 36 positioned circumferentially to maintain sliding contact with electrical paths. The brush assembly may be spring contactors or other suitable contactors that are capable of contacting electrical paths.

Electrical interconnection is made to the insulated conductor line of the wired pipe 999 of FIG. 2A and the switch power line 42. The switch return line 99, remains electrically connected to the pipe body 101 of the wired drill pipe regardless of the switch position. The interior of the switch can be filled with dielectric oil 70 to lubricate moving parts, equalize hydrostatic pressure, and suppress arcing.

The switch described herein could also have applications for powering of inline solenoids, operation of other downhole tools or recharging a power cell. Another embodiment could use wireline for the injection and/or communication or a wireline landed in a special UBHO. Still other embodiments could include any type of wire inside any type of pipe that is capable of mating to a switch.

### Operational Modes

### Injection Mode (Dead Short)

In FIG. 2B, piston 20 is positioned such that the brush contactor 32 couples the switch power line 42 directly to the conductive body 12 of the switch, forming a low-impedance “dead short” between the insulated wire and pipe ground. The resulting current flows from the surface through the insulated conductor, through the brush, into the steel body of the switch mechanism through the injection sub 102 or other electrode and into the formation.

The energized pipe segment thus acts as an electrode for emitting an AC or DC current into the formation, allowing ranging operations. The downhole sensors power line 60 located below the switch remain electrically isolated and protected.

Communication Mode (connected)

In FIG. 3, piston 20 is linearly advanced to a second position, disconnecting the switch return line 42 from ground and coupling it to the sensor power input 60. The piston may include multiple discrete stop positions to allow switching between multiple operational states, including dedicated positions for AC or DC injection or diagnostic grounding.

The return switch conductor 99 connects to an internal ground contact 52 embedded within non-conductive material. This contact is routed through conductor 44 to the tool chassis, thereby permitting low-current DC or AC power and telemetry communications.

In this configuration, no high excitation current flows through the sensor, and high-speed bidirectional communication, such as 60 kbit/s signal exchange via the wired drill pipe, can occur. The switch may also be arranged vertically, inverted, or in series with other tools.

During drilling or ranging, the switch can be electronically actuated from surface or by programmable downhole electronics to alternate between injection and communication modes without tripping the string.

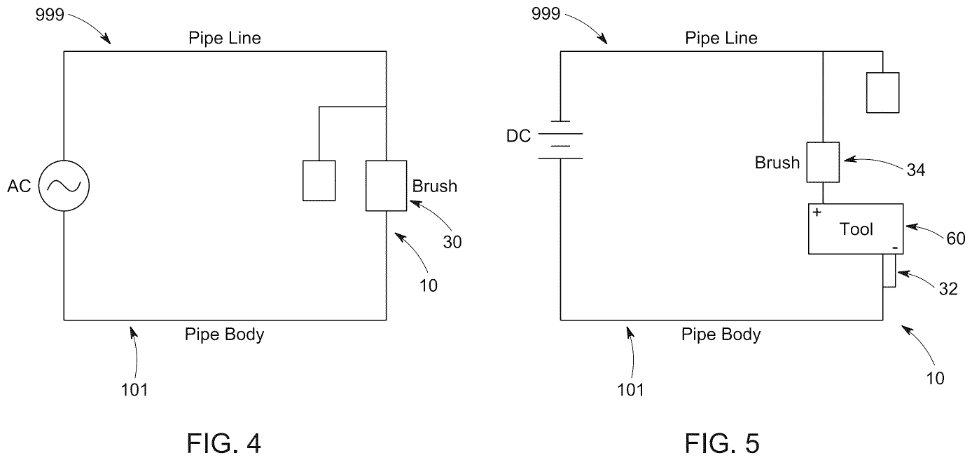

FIG. 4 is a schematic electrical diagram illustrating one configuration of the switch. In this configuration AC current is injected by a power supply. As shown, the circuit shows electrical connection between the wired pipe insulated conductor 999 and pipe body 101 through one or more brush connectors 30.

FIG. 5 is a schematic electrical diagram illustrating an additional configuration of the switch. In this configuration, DC current is used to communicate with downhole tool 60. As shown, the circuit shows electrical connection between pipe line 999, through to switch line 42, which in the extended position makes contact with spring contactor 46, which flows power and comms to tool 60. The return path for the tool is through conductor 44 which is connected to contactor 52, which is electrically connected to 99 which is electrically connected to pipe body 101.

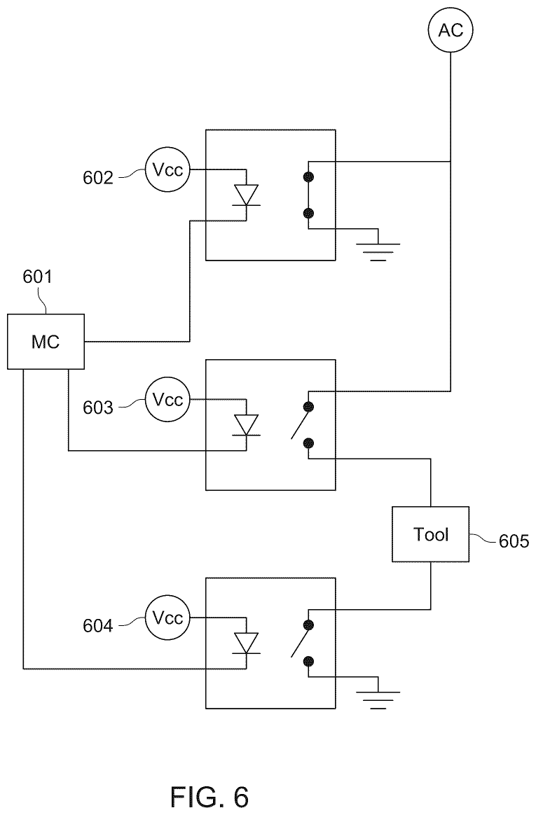

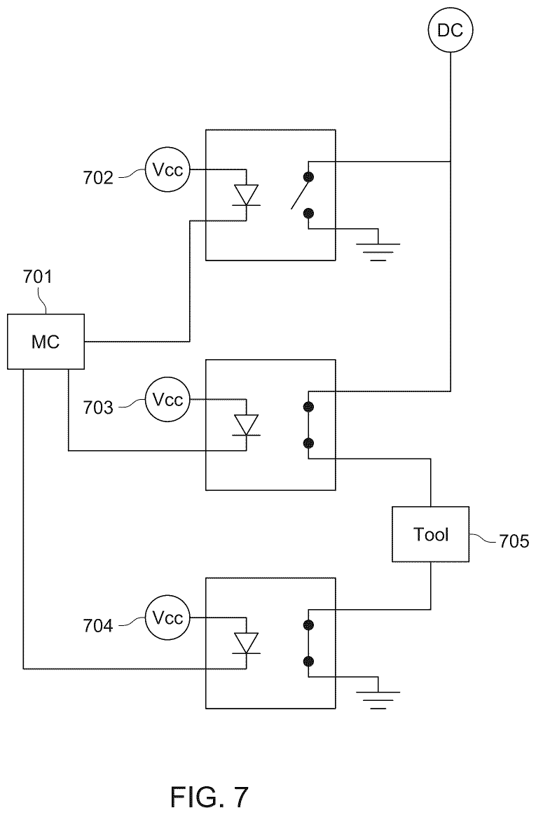

A similar system may be implemented using solid state components. FIGS. 6 and 7 show the proposed configuration and two states of the system supporting delivery of AC power for formation excitation FIG. 6 and delivery of DC power to the tool FIG. 7, facilitating communication with the surface. The system consists of a microprocessor (MC) 601, 701 which controls three solid state relays (SSRs) 602-604, 702-702. When AC current is supplied from surface on an isolated line the first SSR 602 is on, shorting the current to the drillpipe, providing excitation to the formation. Two other SSRs are off 603 and 604, isolating the measurement tool 605. When DC current is supplied the first SSR 702 is off and the second SSR 703 is on, supplying the DC current to the tool 705. The third SSR 704 is on, providing ground for the measurement tool 705. The tool can communicate to surface using the insulated line and ground provided by the drillpipe. The tool can be understood to contain an internal battery which allows it to collect data during the period of time that it is isolated and current is being directed to the drillpipe. The microprocessor can be controlled by interruption of the pumps and the tool can be controlled by detection of the interruption of external DC power. The SSRs could be replaced by functionally similar mechanical relays or IGBT units.

While the inventions have been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

What is claimed is:

1. A downhole switch comprising:
a body having a conductive portion and an insulative portion wherein the conductive portion is capable of being electrically connected to a drill pipe;
a non-conductive piston disposed within the body and movable between at least two positions;
at least one contactor disposed to selectively connect an insulated conductor to either (a) the conductive portion of the body or (b) a tool power line, and
whereby the switch selectively establishes a dead short to ground for current injection or a conductive path for communication with a downhole component.

2. The switch of claim 1, wherein the conductive portion comprises steel and the insulative portion comprises PEEK.

3. The switch of claim 1, wherein the piston is actuated by a linear actuator.

4. The switch of claim 1, wherein the interior of the body is filled with a dielectric oil.

5. The switch of claim 1, wherein the switch is configured to handle alternating current in the range of hundreds of volts and tens of amps during current injection.

6. The switch of claim 1, wherein the switch is further configured to handle direct current and communications in the range of hundreds of volts and tens of milliamps.

7. The switch of claim 1 wherein the piston is actuated by a solenoid.

8. The switch of claim 1 wherein the piston is actuated by a hydraulic driver.

9. The switch of claim 1 wherein the downhole component is a sensor.

10. A method for controlling current injection and communication in a downhole system, comprising the steps of:
(a) providing a wired drill pipe having an insulated conductor;
(b) positioning a switch above a sensor tool, the switch having a conductive portion and an insulative portion wherein the conductive portion is capable of being electrically connected to the wired drill pipe;
(c) actuating a piston in the switch to a first position to short the insulated conductor to a conductive drill pipe body for injecting current into a formation; and
(d) actuating the piston to a second position to couple the insulated conductor to a tool input line.

11. The method of claim 10, further comprising filling the switch interior with dielectric oil.

12. The method of claim 10, wherein current injection is performed using AC or DC excitation, and communication is performed using low-power DC telemetry.

13. A downhole electrical system comprising:
a wired pipe;
an insulated conductor;
a switch that is capable of alternately connecting the insulated conductor to ground for formation stimulation or to a sensor for communication.

14. The downhole electrical system of claim 13 further comprising a gap sub.
